(19) United States
(12) Patent Application Publication
(10) Pub. No.: US 2010/0188837 A1
(43) Pub. Date: Jul. 29, 2010

(54) COLOR CONVERSION DEVICE AND COLOR CONTROLLABLE LIGHT-OUTPUT DEVICE

(75) Inventors: Ties Van Bommel, Eindhoven (NL); Rifat ATa Mustafa Hikmet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/669,827

(22) PCT Filed: Jul. 21, 2008
(86) PCT No.: PCT/IB08/52913

§ 371 Date: Jan. 20, 2010

(30) Foreign Application Priority Data
Jul. 25, 2007 (EP) 07113072.8

(51) Int. Cl. F21V 9/16; F21S 8/10; F21V 9/00

(52) U.S. Cl. 362/84; 362/317; 362/293

(57) ABSTRACT

A color conversion device (10; 20; 30; 40; 51; 60), for adjusting a color of light emitted by a light-source, the color conversion device comprising a beam-shaping member (11; 54; 61; 70; 80; 90; 100) configured to change a shape of a beam of light interacting with the beam-shaping member; and at least a first wavelength converting member (12; 22a-b; 31; 41a-b; 56; 62a-g) configured to absorb light having a first wavelength distribution, and, in response thereto, emit light having a second wavelength distribution, different from the first wavelength distribution. The beam-shaping member (11; 54; 61; 70; 80; 90; 100) is controllable to direct a first fraction of the beam of light towards the first wavelength converting member (12; 22a-b; 31; 41a-b; 56; 62a-g), where a wavelength distribution of the first fraction is converted, thereby enabling color adjustment of the beam of light.

### TECHNICAL FIELD OF THE INVENTION

The present invention relates to a color conversion device for adjusting a color of light emitted by a light source.

The invention further relates to a color controllable light-output device comprising such a color conversion device and a light-source.

### TECHNICAL BACKGROUND

Although many new kinds of light-sources have been developed, the traditional light-bulb is still in abundant use due to its low price and pleasant emission spectrum.

However, due to the ever increasing need for more energy efficient lighting solutions, it is expected that most light-bulbs will eventually be replaced by more energy efficient light-sources.

One of the most promising candidates for achieving energy efficient lighting is a light-emitting diode (LED) based light-source. Since individual LEDs are essentially mono-color light-sources, several LEDs emitting differently colored light are typically grouped to form a LED-arrangement that emits white light.

However, such a LED-arrangement has a fixed emission spectrum, which is typically not well suited for every conceivable application or situation.

For increased versatility, a color controllable LED-based light output device would be desirable.

U.S. Pat. No. 6,357,889 discloses such color controllable light-output device having multiple light-emitting diodes with different emission spectra, and a transmissive plate coated with a phosphor coating. The phosphor coating converts the color of the diodes, and the emission spectrum of the light-output device can be controlled by individually controlling the respective intensities of the differently colored light-emitting diodes.

A drawback of this approach is that adjustment of the color of the light output by the light-output device according to U.S. Pat. No. 6,357,889 will typically entail simultaneous adjustment of the intensity of several of the differently colored light-emitting diodes, for which a relatively complicated control system is required, which leads to a high cost for the light-output device.

Moreover, the differently colored light-emitting diodes comprised in the light-output device according to U.S. Pat. No. 6,357,889 will degrade differently with age, leading to a time dependent change in the driving parameters for the light-emitting diodes for achieving a given color setting. To compensate for this, a feedback system would typically be required, which would further contribute to the cost of the light-output device.

### SUMMARY OF THE INVENTION

In view of the above-mentioned and other drawbacks of the prior art, a general object of the present invention is to provide an improved and/or more cost-efficient color controllable light-output device.

According to a first aspect of the present invention, these and other objects are achieved through a color conversion device, for adjusting a color of light emitted by a light-source, the color conversion device comprising a beam-shaping member configured to change a shape of a beam of light interacting with the beam-shaping member; and at least a first wavelength converting member configured to absorb light having a first wavelength distribution, and, in response thereto, emit light having a second wavelength distribution, different from the first wavelength distribution, wherein the beam-shaping member is controllable to direct a first fraction of the beam of light towards the first wavelength converting member, where a wavelength distribution of the first fraction is converted, thereby enabling color adjustment of the beam of light.

The present invention is based upon the realization that the color of a beam of light emitted by a light-source, such as a mono-chrome LED, can be controlled by redirecting a fraction of the beam of light towards a wavelength converting member, where the color of the redirected light is converted, and mixing the converted fraction of the beam of light with the remaining, un-converted portion of the beam of light. By changing the fraction of light directed towards the wavelength converting member, the mixing ratio between converted and un-converted light, and hence the color of the total beam of light, can be adjusted, from the color point of the un-converted light to the color point of the converted light, along a line in color space.

Through the invention, the color of light can thus be changed by altering the direction of light emitted by a single light-source, rather than by simultaneously adjusting the relative intensities of several differently colored light-sources.

Hereby, a color controllable light-output device can be accomplished which is less complicated to control, and more cost-efficient, compared to the prior art.

The color conversion device according to the present invention may be automatically controlled, for example in response to an input signal from a suitable sensor, or be manually controlled.

The color conversion device according to the present invention may comprise a single wavelength converting member, or several wavelength converting members configured to convert a first wavelength distribution to mutually different respective wavelength distributions.

By providing several such wavelength converting members, the color gamut which is accessible for the color conversion device can be expanded.

The wavelength converting member(s) may advantageously comprise an active wavelength converting substance, which is based on a photoluminescent substance such as fluorescent of phosphorescent dyes. The wavelength converting substance may be formed by particles such as polymers, crystals, clusters, molecules, atoms etc., and may be fluid or solid.

Furthermore, the wavelength converting member(s) may be reflective or optically transparent, that is, at least partly transparent to light, depending on application.

Moreover, the beam-shaping member may advantageously comprise an electro-optical element which is controllable between beam-shaping states through application of a voltage thereto.

An “electro-optical element” should, in the context of the present application, be understood as an optical element, at least one optical property of which is controllable through the application of a voltage to the optical element. An electro-optical element in non-mechanical and has no moving structural parts.

Electro-optical elements are generally compact, energy-efficient and can be switched very rapidly as compared to mechanical optical elements, such as conventional zoom lenses etc.

A large variety of electro-optical elements may by utilized in the color conversion device according to the present invention. Such electro-optical elements may, for example, be configured to achieve beam-shaping through controlled scattering, refraction, diffraction or reflection of light, or through a combination of these mechanisms.

Furthermore, the beam-shaping member may advantageously have a plurality of individually controllable pixels, each configured to controllably change the shape of a sub-beam of light passing therethrough. For example, the light incident on a particular pixel may be controllably reflected, scattered, refracted or diffracted, depending on the beam-shaping mechanism utilized in the particular beam-shaping member.

With such a pixelated beam-shaping member, one can change the amount of light redirection by means of a control signal, such as a voltage, applied to a particular beam-shaping pixel as well as by selecting the number and locations of activated beam-shaping pixels.

Hereby, one can selectively direct light on specific wavelength converting members having different wavelength conversion properties.

According to one embodiment of the present invention, the beam-shaping member may comprise an electro-optical element configured to change the shape of a beam of light passing therethrough by controlling the orientation(s) of liquid crystal molecules comprised therein.

By controlling the orientation of liquid crystal molecules, the direction of light can be controlled through scattering, refraction, diffraction or reflection.

According to another embodiment of the present invention, the beam-shaping member may include two immiscible fluids having different indices of refraction. By controlling the shape of the meniscus formed between the fluids, the shape of a beam of light passing therethrough can be controlled through refraction.

The shape of the meniscus can, for example, be controlled through electrowetting, as is well-known in the art.

Moreover, the color conversion device according to the present invention may advantageously be comprised in a color controllable light-output device, further including a light-source configured to emit a beam of light having the first wavelength distribution, which is convertible by the at least first color converting member comprised in the color conversion device.

The light-output device may be configured for illumination, or for creating an ambience, depending on application.

The light-source may advantageously include a semiconductor-based light-source, such as a mono-color LED or a semiconductor laser.

The color controllable light-output device may further include an additional optical element arranged between the light-source and the color conversion device, and configured to pre-shape the beam of light output by the light-source to improve the interaction with the color conversion device.

This additional optical element may, for example, be a collimator.

### BRIEF DESCRIPTION OF THE DRAWINGS

These and other aspects of the present invention will now be described in more detail, with reference to the appended drawings showing currently preferred embodiments of the invention, wherein:

FIGS. 1a-b schematically illustrate a color conversion device according to a first embodiment of the present invention;

FIGS. 2a-b schematically illustrate a color conversion device according to a second embodiment of the present invention;

FIGS. 3a-b schematically illustrate a color conversion device according to a third embodiment of the present invention;

FIGS. 4a-b schematically illustrate a color conversion device according to a fourth embodiment of the present invention;

FIGS. 5a-b schematically illustrate a color conversion device according to a fifth embodiment of the present invention;

FIGS. 6a-b schematically illustrate a color conversion device according to a sixth embodiment of the present invention;

FIGS. 7a-b schematically illustrate a first exemplary beam-shaping member utilizing scattering;

FIGS. 8a-b schematically illustrate a second exemplary beam-shaping member utilizing scattering;

FIGS. 9a-b schematically illustrate a third exemplary beam-shaping member utilizing refraction; and

FIGS. 10a-c schematically illustrate a fourth exemplary beam-shaping member utilizing refraction.

### DETAILED DESCRIPTION OF PREFERRED EMBODIMENTS OF THE INVENTION

In the following description, the present invention is described with reference to a selection of exemplary beam-shaping devices utilizing different electro-optical effects. It should be noted that this by no means limits the scope of the invention, which is equally applicable to many other beam-shaping devices, utilizing other electro-optical effects, such as liquid crystal gel scattering, electrophoresis, control of particles suspended in a fluid (so-called suspended particle device) etc.

Furthermore, although the wavelength converting members comprised in the various embodiments are throughout referred to as a “phosphor-layers”, it should be understood that “phosphor” is here merely used as a representative color converting substance.

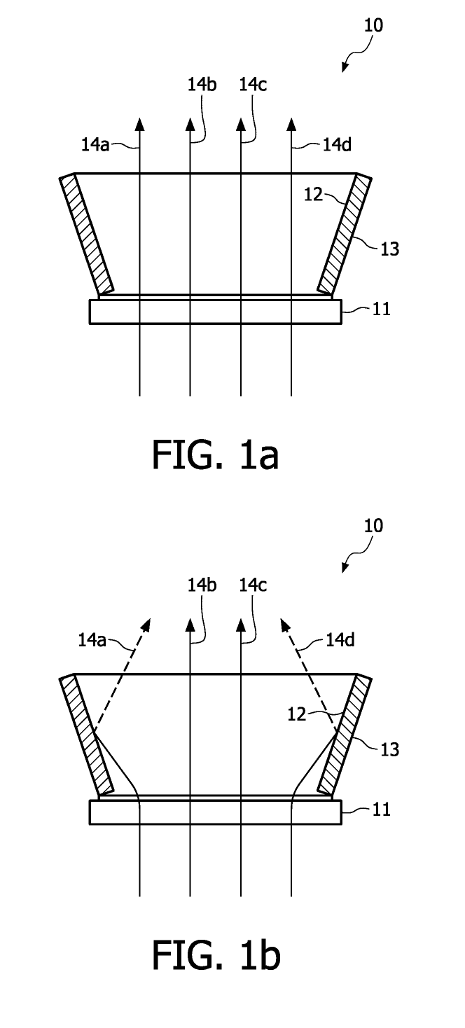

First, various basic configurations for embodiments of the color conversion device according to the present invention will be described with reference to FIGS. 1 to 5. All of these figures are section views of devices which are typically symmetric with respect to a vertical center line through the respective section views. The devices may, for example, be circularly symmetric.

Throughout, color converted light is indicated by dashed arrows representing rays of light comprised in the beam of light interacting with the color conversion device.

In FIGS. 1a-b a color conversion device 10 according to a first embodiment of the invention is shown in first and second states, respectively.

The color conversion device 10 comprises a beam-shaping member 11, and a wavelength converting member 12 in the form of a phosphor layer arranged on a collimating reflector 13.

As shown in FIGS. 1a-b, a beam of light having a first wavelength distribution, here represented by four rays of light 14a-d pass through the color conversion device 10.

When the beam-shaping member 11 is in a first beam-shaping state, as is schematically illustrated in FIG. 1a, each of the rays of light 14a-d passes through the color conversion device 10 without being directed towards the wavelength converting member 12. Consequently, the beam of light will still have the first wavelength distribution following passage through the color conversion device, and no color conversion takes place.

When the beam-shaping member 11 is in a second beam-shaping state, as is schematically illustrated in FIG. 1b, a fraction of the beam of light, namely the rays of light 14a and 14d are directed by the beam-shaping member 11 towards the phosphor layer 12. These rays of light 14a and 14d are absorbed by the phosphor layer 12 and are reflected and re-emitted with a different wavelength distribution. The color-converted fraction (ray 14a and 14d) of the light beam are subsequently mixed with the fraction (ray 14b and 14c) of the light beam which is not color-converted, resulting in an intermediate color.

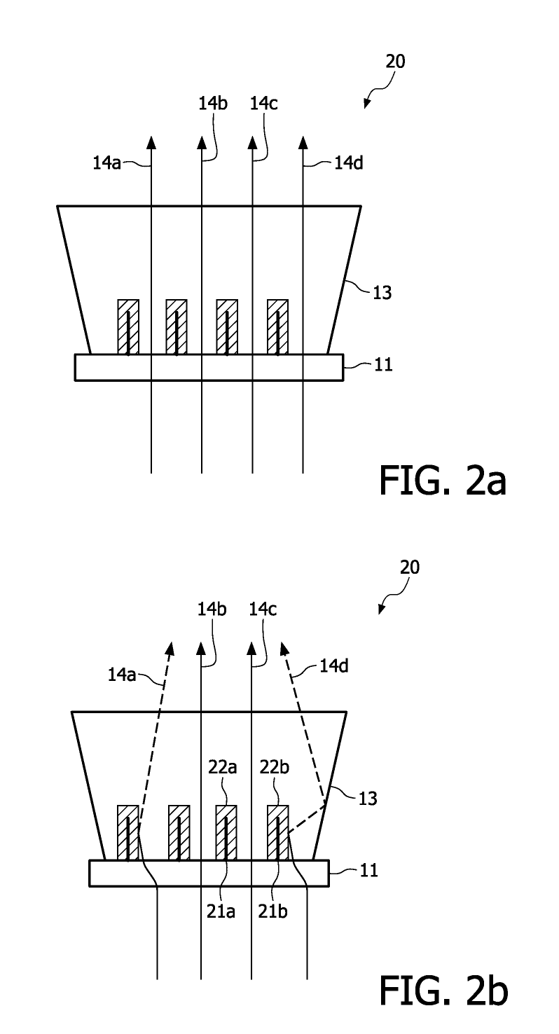

In FIGS. 2a-b a color conversion device 20 according to a second embodiment of the present invention is schematically shown.

This color conversion device 20 differs from the color conversion device 10 shown in FIGS. 1a-b in that the phosphor layer (12 in FIGS. 1a-b) provided on the inside of the reflector 13 has been removed, and in that vertically extending reflectors 21a-b each coated with a phosphor layer 22a-b have been added to the color conversion device 20. The vertically extending reflectors 21a-b in FIGS. 2a-b are provided in the form of concentric reflecting structures, but may of course be provided in other configurations.

As described above in connection with FIGS. 1a-b, FIGS. 2a-b illustrate two states of the color conversion device 20 in which different amounts of light interact with the phosphor layers 22a-b.

The person skilled in the relevant art realizes that the embodiments of FIGS. 1 and 2 can readily be combined to a color converting device having different phosphor layers provided on the collimating reflector 13 and on the vertically extending reflectors 21a-b. Furthermore, each of the reflectors 13, 21a-b may be partly covered by phosphor layers and/or covered with different phosphor layers in different locations.

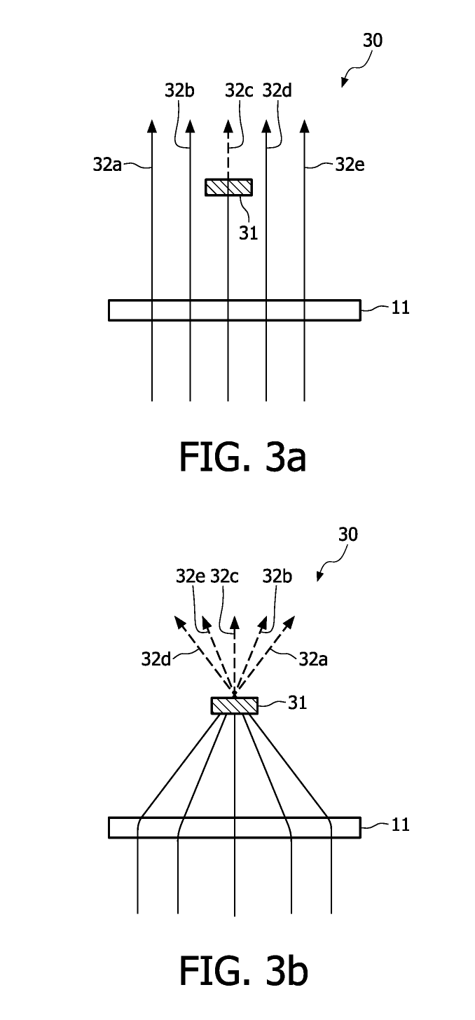

In FIGS. 3a-b a color conversion device 30 according to a third embodiment of the present invention is schematically shown.

This color conversion device 30 differs from the previously described color conversion devices 10, 20 in that the color of the light-beam interacting with the color conversion device 30 in FIGS. 3a-b is controlled by controlling the fraction of the light-beam passing through a transparent wavelength converting member, here provided in the form of a transparent phosphor-coated plate 31.

When the beam-shaping member 11 is in a first beam-shaping state, as is schematically illustrated in FIG. 3a, a first fraction, illustrated by the ray 32c is directed towards the transparent phosphor-coated plate 31 and passes therethrough while undergoing color conversion. The remainder of the light-beam, as illustrated by the remaining rays 32a, 32b, 32d, 32e pass through the color converting device without undergoing color conversion.

When the beam-shaping member 11 is in a second beam-shaping state, as schematically illustrated in FIG. 3b, a second fraction of the beam of light, represented by all the rays 32a-e in FIG. 3b are directed by the beam-shaping member 11 to pass through the phosphor layer 31. These rays of light 32a-e are absorbed by the phosphor layer 31 and re-emitted with a different wavelength distribution, resulting in a converted color of light.

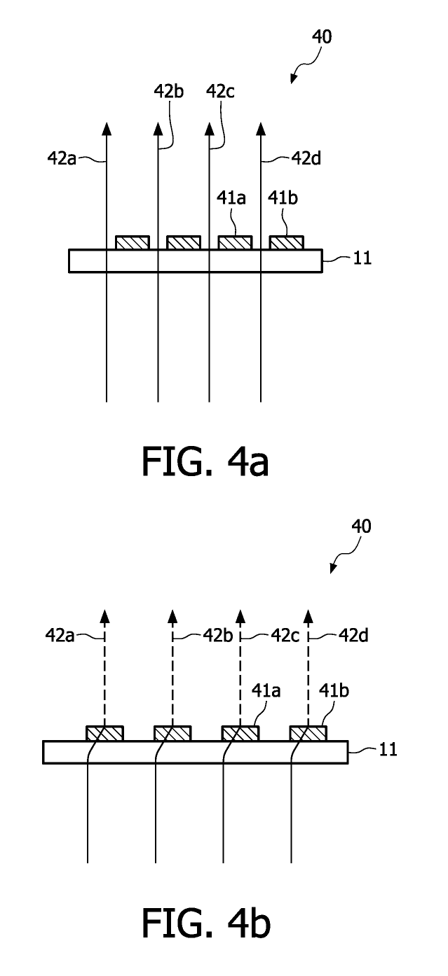

In FIGS. 4a-b a color conversion device 40 according to a fourth embodiment of the present invention is schematically shown.

This color conversion device 40 differs from the color conversion device 30 described with reference to FIG. 3 in that transparent wavelength converting members 41a-b are provided as a patterned phosphor layer on the beam-shaping member 11. In the presently illustrated example, the phosphor layer is patterned into two concentric rings 41a-b. It should, however, be noted that the phosphor layer may be patterned into any suitable shape depending on the particular application, such in the form of dots or lines, etc. By shaping the light beam interacting with the color conversion device 40, the fraction of the beam hitting the patterned phosphor layer 41a-b can be controlled from a very small fraction as schematically illustrated in FIG. 4a, where none of the rays 42a-d is directed towards the phosphor layer 41a-b, to a large fraction as schematically illustrated in FIG. 4b, where all of the rays 42a-d are directed towards the phosphor layer 41a-b.

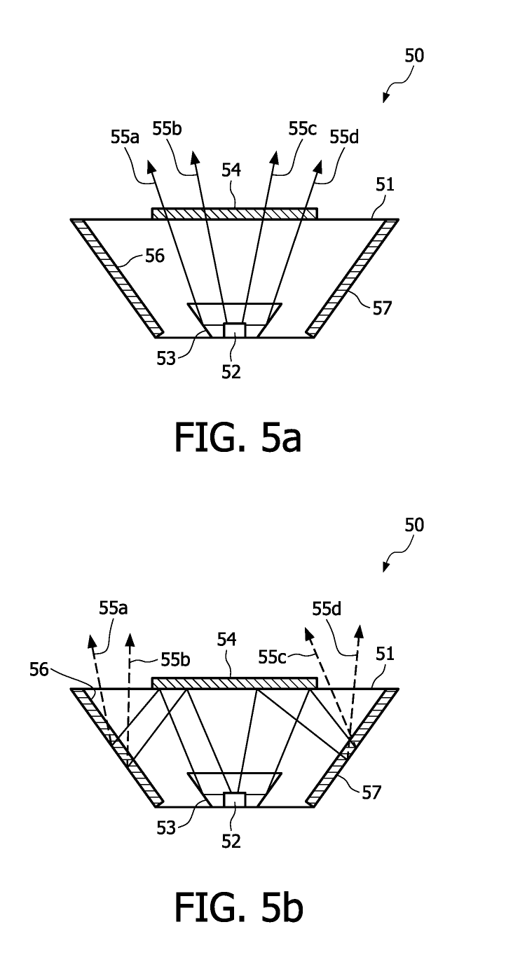

In FIGS. 5a-b a light-output device 50 comprising a color conversion device 51 according to a fifth embodiment of the present invention is schematically shown.

The light-output device 50 in FIGS. 5a-b further comprises a light-source 52, here provided in the form of a single mono-color LED and a primary collimator 53 arranged to collimate the light emitted by the LED 52 as is schematically illustrated in FIGS. 5a-b.

The color conversion device 51 in FIGS. 5a-b differs from the previously described embodiments in that the beam-shaping member 54 is configured to direct a fraction of the light-beam, represented by the rays 55a-d, emitted by the LED 52 towards the phosphor layer 56 provided on the secondary collimator 57 by means of controlled reflection. Such a beam-shaping member 54 can, for example, be realized utilizing a so-called cholesteric liquid crystal mirror as described in WO2007/008235.

Referring first to FIG. 5a, the beam-shaping member 54 is in a non-reflecting state, and consequently permits the entire light-beam (rays 55a-d) emitted by the LED 52 to pass therethrough. In this state, the light output by the light-output device 50 will thus have the color originally emitted by the LED 52.

Turning now to FIG. 5b, the beam-shaping member has been switched to a completely reflecting state, whereby the entire light-beam (rays 55a-d) is reflected towards the phosphor layer 56 provided on the secondary collimator 57. In this state, the light output by the light-output device 50 will thus have the color into which the light originally emitted by the LED 52 is converted by the phosphor layer 56.

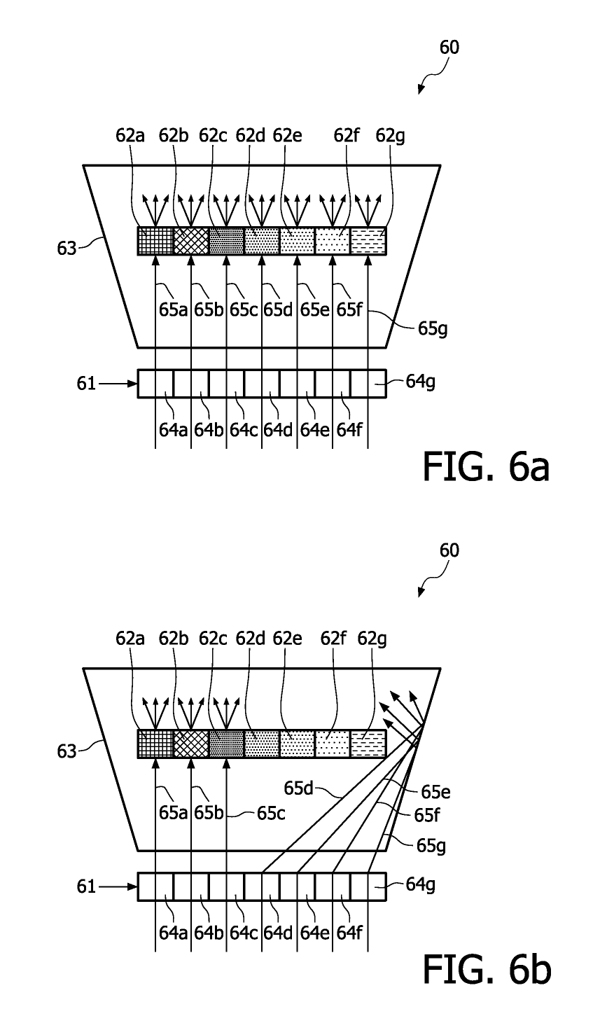

In FIGS. 6a-b a color conversion device 60 according to a sixth embodiment of the present invention is schematically shown.

As shown in FIGS. 6a-b, the color conversion device 60 comprises a pixelated beam-shaping member 61, a plurality of wavelength converting members 62a-g, which may, for example, be provided in the form of different phosphor layers on an optically transparent plate, and a collimating reflector 63.

The beam-shaping member 61 has a plurality of individually controllable beam-shaping pixels 64a-g. Each of these pixels 64a-g can be switched between beam-shaping states.

In FIG. 6a, which shows the color conversion device 60 in a first color conversion state, every beam-shaping pixel 64a-g of the beam-shaping device 61 is controlled to permit passage of an incident beam of light, represented by the rays 65a-g, through the beam-shaping member 61. After its respective passage through the beam-shaping device 61, each ray 65a-g hits a different respective color conversion member 62a-g, and is converted to a corresponding color. After re-emission by the color conversion members 62a-g, a color converted beam of light is achieved through mixing of the color converted sub-beams, each represented by a respective ray 65a-g.

Turning now to FIG. 6b, the color conversion device 60 is shown in a second color conversion state, in which a first fraction of the beam of light, represented by the rays 65a-c are directed by the beam-shaping device 61 to hit the same respective color conversion members 62a-c as in FIG. 6a, and a second fraction of the beam of light, represented by the rays 65d-g is directed by the beam-shaping member 61 in such a way that these rays 65d-g pass beside the color conversion members 62a-g and are not color converted. The second fraction of the beam of light (rays 65d-g) is instead reflected by the collimating reflector 63 to mix with the converted, first fraction of the beam of light (rays 65a-c), whereby a different color is achieved.

In each of the previously described embodiments of the color conversion device according to the present invention, the beam-shaping member may be controlled to intermediate states between no beam-shaping and maximum beam-shaping. As for the present fifth embodiment, in such an intermediate state, a first fraction of the light-beam emitted by the LED 52 would pass through the beam-shaping member 54 with a substantially unchanged emission spectrum, and a second fraction would be reflected by the beam-shaping member 54 towards the phosphor layer 56, where active color conversion takes place, and reflected by the secondary collimator 57 to mix with the first fraction, resulting in output by the light-output device 50 of light having a color between the color of the first fraction and the color of the second fraction, in color space.

Above, six exemplary embodiments of the color conversion device according to the present invention have been described. As is readily understood by the person skilled in the art, these embodiments represent examples only, and many variations to the embodiments and combinations thereof are possible without departing from the scope of the present invention.

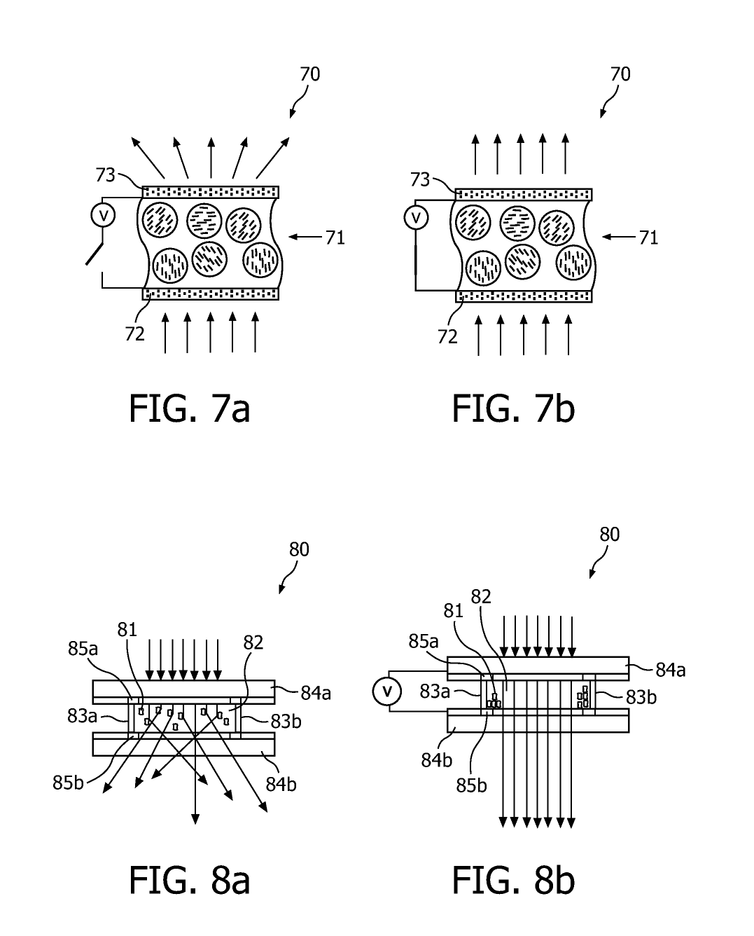

In the following, with reference to the exemplary illustrations in FIGS. 7 to 10, representative examples of different beam-shaping mechanisms that can be utilized in the beam-shaping member comprised in the color conversion device according to the present invention are provided. It should be noted that the following description is not an exhaustive presentation of beam-shaping member embodiments, but simply an illustration of various mechanisms that may advantageously be used.

First, with reference to FIGS. 7a-b and FIGS. 8a-b, two exemplary beam-shaping members will be illustrated, which utilize electrically controllable scattering to achieve the desired beam-shaping.

In FIGS. 7a-b a beam-shaping member 70 utilizing so-called Polymer Dispersed Liquid Crystals (PDLCs) is schematically illustrated.

Polymer Dispersed Liquid Crystals (PDLCs) are created by dispersing liquid crystals molecules in an isotropic polymer. The liquid crystal material (micron sized nematic droplets of liquid crystal dispersed in an isotropic polymer matrix) is arranged in a cell 71 between first 72 and second 73 substrates, such as glass plates, which are each provided with transparent electrodes (not shown). When no electric field is applied between the electrodes, the liquid crystals are randomly oriented, which creates a scattering mode as illustrated in FIG. 7a. Due to the random orientation of the liquid crystal molecules, both polarizations of the light are affected.

By applying an electric field, the scattering gradually decreases, and when the liquid crystal molecules align in parallel to the electric field, the refractive index of the liquid crystal molecules matches the polymer refractive index, whereby a transparent mode is achieved and light passes through the cell without being redirected as is illustrated in FIG. 7b.

As an alternative to the beam-shaping mechanism schematically illustrated in FIGS. 7a-b, controlled scattering of light can be achieved using a liquid crystal gel instead of the above-described PDLC. Liquid crystal gels are liquid crystal molecules in the presence of a three dimensional polymer network. The macroscopically oriented liquid crystal gels have no refractive index mismatch within the gel and are therefore transparent and cause no light scattering. By application of an electric field, the liquid crystal molecules in the polymer network are reoriented, causing large-scale refractive index fluctuations within the gels thereby giving rise to light scattering.

In FIGS. 8a-b a beam-shaping member 80 utilizing electrophoresis is schematically illustrated.

The beam-shaping member 80 in FIGS. 8a-b includes a plurality of charged particles 81 (here represented by a single particle) suspended in a fluid 82. The particle-fluid suspension is enclosed in a cell bounded by side walls 83a-b and top and bottom walls 84a-b. To enable control of the charged particles 81, electrodes 85a-b are provided at suitable locations in the cell. By applying a voltage between these electrodes 85a-b, the shape of a beam of light passing through the beam-shaping member 80 can be controlled.

In FIG. 8a, a first state is illustrated in which no voltage is applied between the electrodes 85a-b. In this state, the charged particles 81 are essentially uniformly dispersed in the fluid 82 and scatter the light passing through the particle-fluid suspension, as illustrated in FIG. 8a.

In FIG. 8b, a second state is illustrated in which a voltage is applied between the electrodes 85a-b. Due to the electric field resulting from the application of the voltage V, the particles 81 are displaced, such that a large portion of the cell is free from particles. Consequently, light passing through the cell does not encounter any particles 81 and is not scattered, as is schematically illustrated in FIG. 8b. It should be noted, that in addition to its primary beam-shaping functionality, the present embodiment of the beam-shaping member 80 can be used to achieve color conversion of the scattered light. This can be accomplished by providing particles 81 capable of active wavelength conversion. For example, the particles 81 may include a suitable fluorescent material.

Beam-shaping by means of controlled scattering of light by particles suspended in a fluid can also be achieved through other well-known techniques, such as electrowetting, reorientation of anisotropic particles suspended in a fluid, etc.

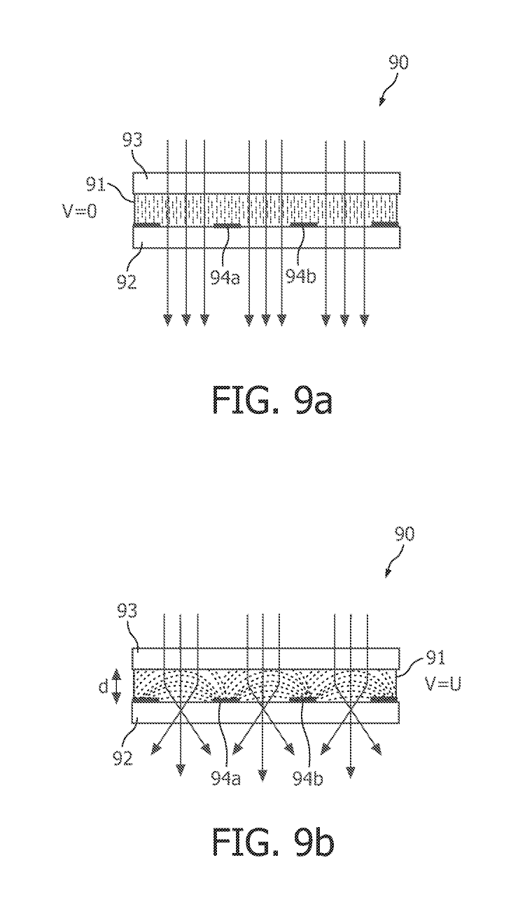

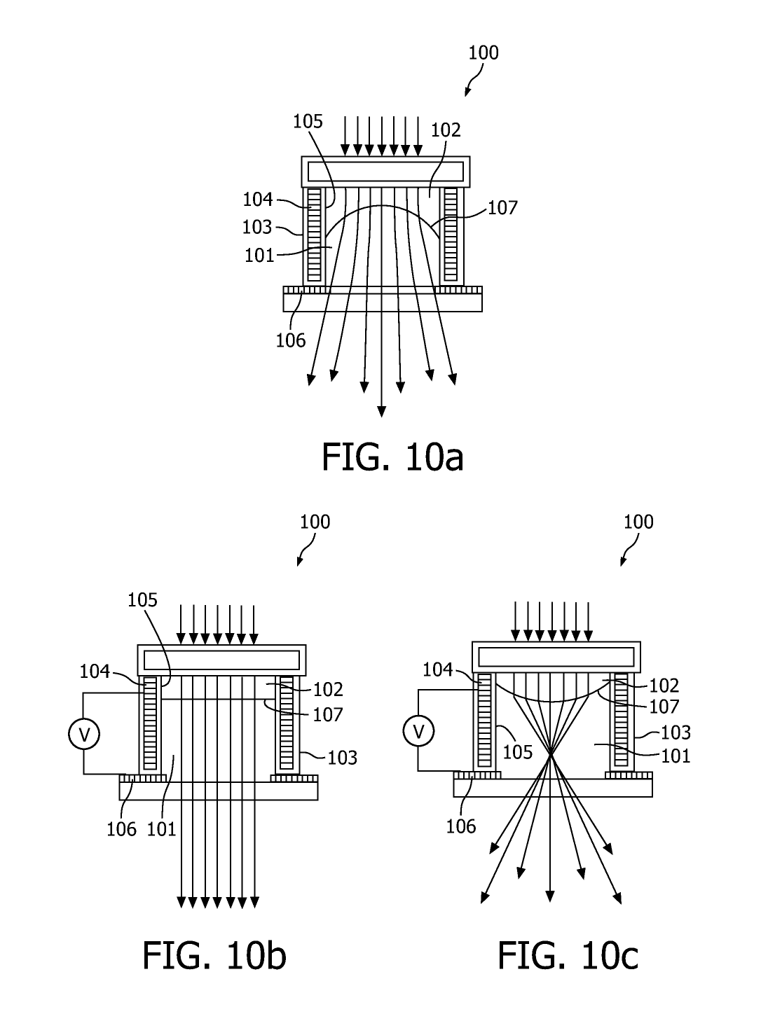

Second, with reference to FIGS. 9a-b and FIGS. 10a-c, two exemplary beam-shaping members will be illustrated, which utilize electrically controllable refraction to achieve the desired beam-shaping.

In FIGS. 9a-b a beam-shaping member 90 is schematically illustrated in which light redirection is achieved by means of a controlled refractive index gradient in a liquid crystal layer.

The beam-shaping member 90 in FIG. 9a-b is a so-called gradient index microlens array having a liquid crystal layer 91 sandwiched between a first 92 and a second 93 substrate. The first substrate 92 has first 94a and second 94b electrodes provided on a side thereof facing the liquid crystal layer 91.

When no voltage is applied between the electrodes 94a-b, there is no electric field acting on the LC molecules comprised in the LC-layer 91. In this state, the orientation of the LC molecules is determined by alignment layers (not shown) provided on the first 92 and second 93 substrates. In the exemplary embodiment illustrated in FIG. 9a, the LC molecules are homeotropically aligned, perpendicular to the substrates 92, 93, and the shape of a beam of light passing through the beam-shaping member 90 is not affected thereby, as is schematically illustrated in FIG. 9a.

In FIG. 9b, the beam-shaping member 90 is in a second state, in which a voltage is applied between the electrodes 94a-b, giving rise to an electric field in the LC-layer 91. The LC molecules comprised in the LC-layer 91 tend to orient themselves along the electric field lines leading to the formation of a refractive index gradient in the LC-layer 91.

Hereby the light passing through the beam-shaping member 90 can be focussed as shown in FIG. 9b. The beam-shaping member 90 shown in FIGS. 9a-b only affects one polarization component of incident unpolarized light.

By arranging two liquid crystal cells in a stacked structure both polarization components can be controlled.

In FIGS. 10a-c a beam-shaping member 100 is schematically illustrated in which light redirection is achieved by controlling the shape of a lens formed by the mensicus between two immiscible fluids.

The beam-shaping member 100 in FIGS. 10a-c is a so-called fluid focus cell, in which a first fluid 101, such as a polar liquid, and a second fluid 102, such as a non-polar liquid, are contained. On the inside of the side wall 103, a first electrode 104 is provided, covered by a hydrophilic layer 105. By applying a voltage between the first electrode 104 provided on the side wall 103 and a second electrode 106 which is in contact with the first fluid 101, the position of the meniscus 107 along the wall can be controlled, as is illustrated for three different states in FIGS. 10a-c.

The person skilled in the art realizes that the present invention by no means is limited to the preferred embodiments. For example, several fluorescent structures configured to convert light to different wavelength spectra can be included in the color conversion device. Furthermore, various other optical elements, such as filters, lenses, reflectors, polarizers etc. may be included in the color conversion device as required for the particular application. For example, a lens or other static optical element may be arranged to modify at least one property, such as the shape, of the light beam following its interaction with the beam-shaping member.

1. A color conversion device for adjusting a color of light emitted by a light-source, said color conversion device comprising:
a beam-shaping member configured to change a shape of a beam of light interacting with said beam-shaping member; and
at least a first wavelength converting member configured to absorb light having a first wavelength distribution, and, in response thereto, emit light having a second wavelength distribution, different from said first wavelength distribution,
wherein said beam-shaping member is controllable to direct a first fraction of said beam of light towards said first wavelength converting member such that a wavelength distribution of said first fraction is converted, thereby enabling color adjustment of said beam of light.

2. A color conversion device according to claim 1, wherein said beam-shaping member is controllable between first and second beam-shaping states, enabling direction of first and second fractions, respectively, of said beam of light towards said at least first wavelength converting member, said first fraction being different from said second fraction.

3. A color conversion device according to claim 1, wherein said at least first wavelength converting member comprises a fluorescent material.

4. A color conversion device according to claim 1, further comprising a second wavelength converting member configured to absorb light having a first wavelength distribution, and, in response thereto, emit light having a third wavelength distribution, different from said first wavelength distribution, wherein said beam-shaping member is further controllable to direct a second fraction of said beam of light towards said second wavelength converting member, where a wavelength distribution of said second fraction is converted.

5. A color conversion device according to claim 1, wherein said beam-shaping member comprises an electro-optical element which is controllable between beam-shaping states through application of a voltage (V) thereto.

6. A color conversion device according to claim 5, wherein said beam-shaping member is configured to change said shape of said beam of light through controlling scattering of light.

7. A color conversion device according to claim 5, wherein said beam-shaping member is configured to change said shape of said beam of light through controlling diffraction and/or refraction of light.

8. A color conversion device according to claim 5, wherein said beam-shaping member is configured to change said shape of said beam of light through controlling reflection of light.

9. A color conversion device according to claim 5, wherein said beam-shaping member comprises a plurality of liquid crystal molecules.

10. A color conversion device according to claim 7, wherein said beam-shaping member comprises two immiscible fluids, and said beam-shaping takes place at a meniscus between said immiscible fluids.

11. A color conversion device according to claim 6, wherein said beam shaping member comprises a plurality of electrically controllable particles suspended in a fluid.

12. A color conversion device according to claim 1, wherein said beam-shaping member comprises a plurality of individually controllable beam-shaping pixels.

13. A color controllable light-output device comprising:
a light-source configured to output a beam of light having a first wavelength distribution; and
a color conversion device according to claim 1, arranged to interact with said beam of light output by said light-source.

14. A color controllable light-output device according to claim 13, further comprising a further optical element arranged between said light-source and said color conversion device and configured to pre-shape the beam of light output by the light-source for improved interaction with said color conversion device.

15. A color controllable light-output device according to claim 13, wherein said light-source is a mono-color light-emitting diode.
